(19) United States
(12) Patent Application Publication
(10) Pub. No.: US 2019/0156220 A1
(43) Pub. Date: May 23, 2019

(54) USING MACHINE COMPREHENSION TO ANSWER A QUESTION

(71) Applicant: Microsoft Technology Licensing, LLC, Redmond, WA (US)

(72) Inventors: Chenguang Zhu, Redmond, WA (US); Hsin-Yuan Huang, Bellevue, WA (US); Pengcheng He, Beijing (CN); Weizhu Chen, Kirkland, WA (US); Yelong Shen, Bothell, WA (US); Zheng Chen, Bellevue, WA (US)

(21) Appl. No.: 15/821,552

(22) Filed: Nov. 22, 2017

(51) Int. Cl. G06N 5/02; G06N 7/00

(52) U.S. Cl. CPC G06N 5/02; G06N 7/005

(57) ABSTRACT

Systems and methods for machine comprehension are provided. In example embodiments, a machine accesses a context and a question related to the context. The machine determines a low-level meaning of the question and a low-level meaning of the context, the low-level meaning corresponding to words or phrases. The machine determines a high-level meaning of the question and a high-level meaning of the context, the high-level meaning corresponding to sentences or paragraphs. The machine computes, for each position i in the context, a first probability that an answer to the question starts at the position i. The machine computes, for each position j in the context, a second probability that the answer to the question ends at the position j. The machine determines the answer to the question based on the computed first probabilities and the computed second probabilities.

### BACKGROUND

Teaching machine(s) to read, process, and comprehend a context e.g. a passage of text or spoken communications) and then to answer question(s) about the context may be desirable.

### BRIEF DESCRIPTION OF THE DRAWINGS

Some embodiments of the technology are illustrated, by way of example and not limitation, in the figures of the accompanying drawings.

FIG. 1 illustrates an example computing machine in which machine comprehension may be implemented, in accordance with some embodiments.

FIG. 2 is a flow chart illustrating an example machine comprehension method, in accordance with some embodiments.

FIG. 3 is an example conceptual architecture illustrating fusion processes, in accordance with some embodiments.

FIG. 4 illustrates example data which may be generated in one implementation, in accordance with some embodiments.

FIG. 5 is an example architecture of a fully aware fusion network, in accordance with some embodiments.

FIG. 6 is a block diagram illustrating components of a machine able to read instructions from a machine-readable medium and perform any of the methodologies discussed herein, in accordance with some embodiments.

### SUMMARY

The present disclosure generally relates to machines configured to provide machine comprehension, including computerized variants of such special-purpose machines and improvements to such variants, and to the technologies by which such special-purpose machines become improved compared to other special-purpose machines that provide technology for machine comprehension. In particular, the present disclosure addresses systems and methods for using machine comprehension to answer question(s) about a context (e.g. a passage of text or spoken communications).

According to some aspects of the technology described herein, a system includes processing circuitry; and a memory storing instructions which, when executed by the processing circuitry, cause the processing circuitry to perform operations comprising: accessing a context of text and a question related to the context, the context of text comprising a listing of words, each word having a position; determining a low-level meaning of the question and a low-level meaning of the context, the low-level meaning corresponding to words or phrases; determining a high-level meaning of the question and a high-level meaning of the context, the high-level meaning corresponding to sentences or paragraphs; computing, for each position i in the context, a first probability that an answer to the question starts at the position i, the first probability being based on the low-level meaning of the question, the low-level meaning of the context, the high-level meaning of the question, and the high-level meaning of the context; computing, for each position j in the context, a second probability that the answer to the question ends at the position j the second probability being based on the low-level meaning of the question, the low-level meaning of the context, the high-level meaning of the question, and the high-level meaning of the context; determining the answer to the question based on the computed first probabilities and the computed second probabilities, the answer to the question comprising a contiguous sub-listing of the words in the context; and providing an output representing the answer to the question.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

Some aspects of the technology described herein, referred to as aspects, are directed to using machine comprehension of a context (e.g. a passage of written text) to answer a question about the context. In accordance with some aspect, a machine is to answer a question about a context including multiple words, where the answer to the question is a contiguous sub-listing of the words in the context. According to some implementations, a technical problem of using a machine to answer a question about a context is solved.

In some implementations, processing circuitry of one or more machines accesses a context of text and a question related to the context. The context of text includes a listing of words. Each word has a position. The processing circuitry determines a low-level meaning of the question and a low-level meaning of the context. The low-level meaning corresponds to words or phrases. The processing circuitry determines a high-level meaning of the question and a high-level meaning of the context. The high-level meaning corresponds to sentences or paragraphs. The processing circuitry computes, for each position i in the context, a first probability that an answer to the question starts at the position i. The first probability is based on the low-level meaning of the question, the low-level meaning of the context, the high-level meaning of the question, and the high-level meaning of the context. The processing circuitry computes, for each position j in the context, a second probability that the answer to the question ends at the position j. The second probability is based on the low-level meaning of the question, the low-level meaning of the context, the high-level meaning of the question, and the high-level meaning of the context. The processing circuitry determines the answer to the question based on the computed first probabilities and the computed second probabilities. The answer to the question includes a contiguous sub-listing of the words in the context. The processing circuitry provides an output representing the answer to the question.

### Example Implementations

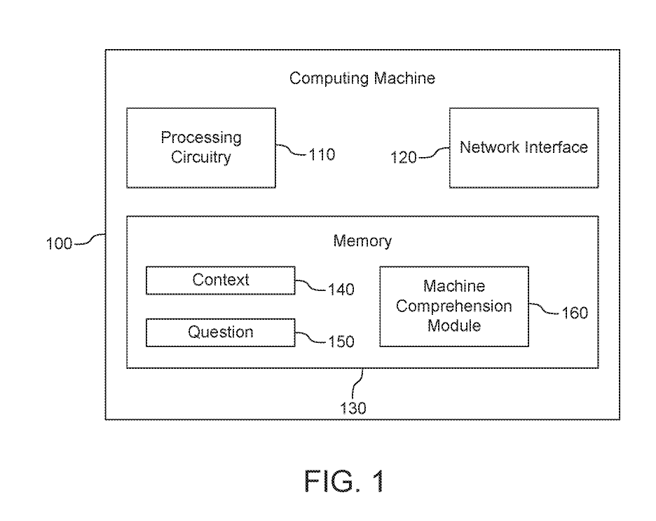

FIG. 1 illustrates an example computing machine 100 in which machine comprehension may be implemented, in accordance with some embodiments. While a single computing machine 100 is illustrated in FIG. 1, the technology described herein may be implemented within a single machine (as shown) or across multiple machines. In the multiple machine implementation, each machine includes all or a portion of the components of the computing machine 100,

As shown, the computing machine 100 includes processing circuitry 110, a network interface 120, and a memory 130. The processing circuitry 110 includes one or more processors, which may be arranged into processing unit(s), such as a central processing unit (CPU) or a graphics processing unit (GPU). The network interface 120 includes one or more network interface cards (NICs) for communicating over network(s), such as a wired network, a wireless network, a local area network, a wide area network, the Internet, an intranet, a virtual private network, and the like. The memory 130 includes a cache unit or a storage unit and stores data or instructions.

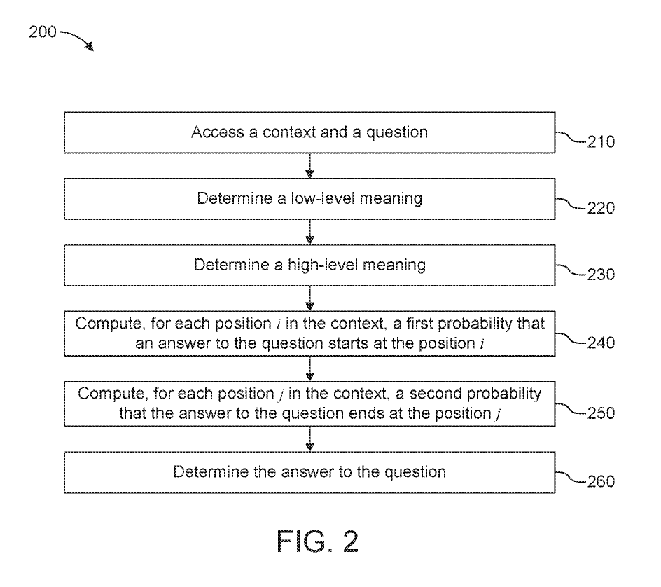

As shown, the memory 130 stores a context 140, a question 150, and a machine comprehension module 160. The context 140 includes information, for example, a passage of text or an audio recording. One example of the context 140 may be the text: “Albany is the capital of the U.S. state of New York and the seat of Albany County. Roughly 150 miles north of New York City, Albany developed on the west bank of the Hudson River.” The question 150 is a question about the context 140. In some examples, the answer to the question 150 is a contiguous span of text (or spoken words) from the context. An example of the question 150 is: “Of which jurisdiction is Albany the capital?” The answer to this question 150 may be “New York”, “U.S. state of New York”, or “the U.S. state of New York”. The machine comprehension module 160 includes instructions which, when executed by the processing circuitry 110, cause the processing circuitry 110 to determine the answer to the question 150 based on the context 140. An example execution of the machine comprehension module 160 is described in conjunction with FIG. 2, below.

FIG. 2 is a flow chart illustrating an example machine comprehension method 200, in accordance with some embodiments. As described below, the method 200 may be implemented at the computing machine 100, when the processing circuitry 110 executes the machine comprehension module 160. However, the method 200 is not limited to the structures shown in FIG. 1, and may be implemented at other machine(s) and using other data structure(s) or other hardware.

At operation 210, the processing circuitry 110 (e.g. while executing the machine comprehension module 160) of one or more machines (e.g. the computing machine 100) accesses a context 140 of text (or speech) and a question 150 related to the context 140. The context 140 of text includes a listing of words. Each word has a position. For example, the first word is at position 1, the second word is at position 2, the nth word is at position 11, etc. Accessing the context 140 and the question 150 may include retrieving the context 140 and the question 150 from memory. Each context and question word may be associated with a pre-computed word vector.

At operation 220, the processing circuitry 110 determines a low-level meaning of the question 150 and a low-level meaning of the context 140. The low-level meaning corresponds to neighboring words and phrases. This is usually done via a bi-directional recursive neural networks (RNN), such as long-short term memory (LSTM). It will generate a low-level meaning from word-level vector. One difference between the technology described herein and the way a typical human does reading comprehension exercises is that humans usually do not read paragraphs backwards. However, bi-directional RNN uses this mechanism to get full neighborhood information for each word, from both the forward and the backward direction.

At operation 230, the processing circuitry 110 determines a high-level meaning of the question 150 and a high-level meaning of the context 150. The high-level meaning corresponds to sentences or paragraphs. This may be done via a bi-directional recursive neural networks, such as long-short term memory (LSTM). The bi-directional recursive neural networks may generate high-level meaning from low-level meaning.

At operation 240, the processing circuitry 110 computes, for each position i in the context 140, a first probability that an answer to the question starts at the position i. The first probability is based on the low-level meaning of the question 150, the low-level meaning of the context 140, the high-level meaning of the question 150, and the high-level meaning of the context 140.

At operation 250, the processing circuitry 110 computes, for each position j in the context 140, a second probability that the answer to the question ends at the position j. The second probability is based on the low-level meaning of the question 150, the low-level meaning of the context 140, the high-level meaning of the question 150, and the high-level meaning of the context 140,

At operation 260, the processing circuitry 110 determines the answer to the question 150 based on the computed first probabilities and the computed second probabilities. The answer to the question 150 includes a contiguous sub-listing of the words in the context 140. The processing circuitry 110 provides an output representing the answer to the question 140. For example, the output may be transmitted via a network or provided for display at a display device. The display device may be coupled to the one or more machines.

In some embodiments, the low-level meaning corresponds to a classification of one or more words or phrases. In some embodiments, the high-level meaning corresponds to a classification of one or more sentences or a paragraph.

In some embodiments, the processing circuitry 110 stores, for each position in the context 140, a history. The history represents one or more low-level meanings associated with a word at the position and one or more high-level meanings associated with the word. The first probability and the second probability are computed based on the history. In some embodiments, the processing circuitry determines an additional-level meaning of the question 150 and an additional-level meaning of the context 140. The history represents one or more additional-level meanings associated with the word at the position. In some embodiments, the first probability and the second probability are computed based on the additional-level meaning.

In some embodiments, in determining the answer to the question 150, the processing circuitry 110 determines a first position where the first probability is maximized and a second position where the second probability is maximized. The processing circuitry 110 then determines that the answer to the question 150 includes the contiguous sub-listing of the words in the context 140 between the first position and the second position.

In some embodiments, an attention score S_{ab} is calculated between each position a in the question 150 and each position b in the context 140. The attention score measures how related the word at positon a is to the word at position b. For example, if the context 140 is “Barack Obama was born on Aug. 4, 1961, in Honolulu, Hi.,” and the question 150 is “When is Barack Obama's birthday,” the attention scores S₃₁ (corresponding to the word “Barack”), 542 (corresponding to the words “Obama's” and “Obama”), and 554 (corresponding to the words “birthday” and “born”) may be high. The use of the attention score allows the computing machine 100 to be aware of the complete understanding of the word at each positon in the question 150 and the context 140, and to compute interrelationships between the words. The history of each ward/position may be used to generate the attention score. In some embodiments of the technology described herein, the history is used for attention score generation only, so that the remainder of the architecture is not directly impacted by potentially noisy information in the possibly long history vector.

Some aspects of the technology disclosed herein relate to a new neural structure called FusionNet, which extends existing attention approach from three perspectives. Some aspects relate to a concept of “history of word” to characterize attention information from the lowest word-level embedding up to the highest semantic-level representation. Some aspects relate to an attention scoring function that better utilize the “history of word” concept. Some aspects relate to a hilly-aware multi-level attention mechanism to capture the complete information in one text (such as question), and exploit it in its counterpart (such as context or passage) layer by layer.

Teaching machines to read, process and comprehend text and then answer questions is one of the key problems in artificial intelligence. In some examples, a machine (or a combination of multiple machines) are fed with a piece of context and a question. The machine is trained to find a correct answer to the question. The machine may possess high capabilities in comprehension, inference, and reasoning to accomplish this task.

One example of a context is: “The Alpine Rhine is part of the Rhine, a famous European river. The Alpine Rhine begins in the most western part of the Swiss canton of Graubunden, and later forms the border between Switzerland to the West and Liechtenstein to the East. On the other hand, the Danube separates Romania and Bulgaria.” One example of a question is: “What is the other country the Rhine separates Switzerland to?” The answer to this question is “Liechtenstein.”

Answering a question based on a context is considered as a challenging task in artificial intelligence and has already attracted numerous research efforts from the neural network and natural language processing communities. This problem may be framed as a machine reading comprehension (MRC) task.

Some aspects ingest information in the question and characterize it in the context, in order to provide an accurate answer to the question. This may be modeled as attention, which is a mechanism to attend the question into the context so as to find the answer related to the question. Some aspects use the word-level embedding from the question to context, while some aspects use the high level representation in the question to augment the context. Some aspects capture full information in the context or the question, which could be vital for complete information digestion. In image recognition, information in various levels of representations can capture different aspects of details in an image: pixel, stroke and shape. In some aspects, this is also useful in language understanding and MRC. In other words, an approach that utilize all the information from the word embedding level up to the highest level representation may be useful for understanding both the question and the context, hence yielding more accurate answers.

In some aspects of the technology described herein, the ability to consider all layers of representation might be limited by the difficulty to make the neural model learn well, as model complexity may surge beyond capacity. To alleviate this challenge, some aspects propose an improved attention scoring function utilizing all layers of representation with less training burden. This leads to an attention that thoroughly captures the complete information between the question and the context. With this fully-aware attention, some aspects provide a multi-level attention mechanism to understand the information in question, and exploit it layer by layer on the context side.

Some aspects relate to the task of machine reading comprehension and the fusion mechanisms employed in existing MRC models. Some aspects relate to the concept of “history of word,” and its light-weight implementation: “fully-aware attention.” Some aspects relate to the end-to-end FusionNet model.

In machine comprehension, given a context and a question, the machine may read and understand (e.g., process in a neural network to develop a higher level of meaning for) the context, then find the answer to the question. The context is described as a sequence of word tokens: C={w₁^{C}, . . . , wₘ^{C}}; and the question as: [symbol] ={ [symbol] , . . . , [symbol] , where in is the number of words in the context, and n is the number of words in the question. In general, m>>n. The answer Ans can have different forms depending on the task. In some examples described herein, the answer Ans is guaranteed to be a contiguous span in the context C, for example, Ans={wᵢ^{C}, . . . , wᵢ₊ₖ^{C}}.

The concept of fusion may be defined as follows. Given two text bodies, body A and body B, where each body contains a set of constituents, fusing body B into body A is to enhance or modify every single constituent in body A with the information from body B. For example, let body A be words in the context, and body B be words in the question. Fusing body B into body A may be done by appending features for each context word to indicate whether this word occurs in the question.

One of fusion may performed through attention. For every constituent xᵢ in body A: (1) A machine (or a combination of multiple machines) computes an attention score Sij ∈ R for each constituent yⱼ in body B; (2) an attention weight αᵢⱼ is formed: αᵢⱼ=exp(Sᵢⱼ)/Σₖexp(Sᵢₖ); and (3) the machine enhances or combines xᵢ with the summarized information of body B, \tilde{y}ᵢ=Σⱼαᵢⱼyⱼ.

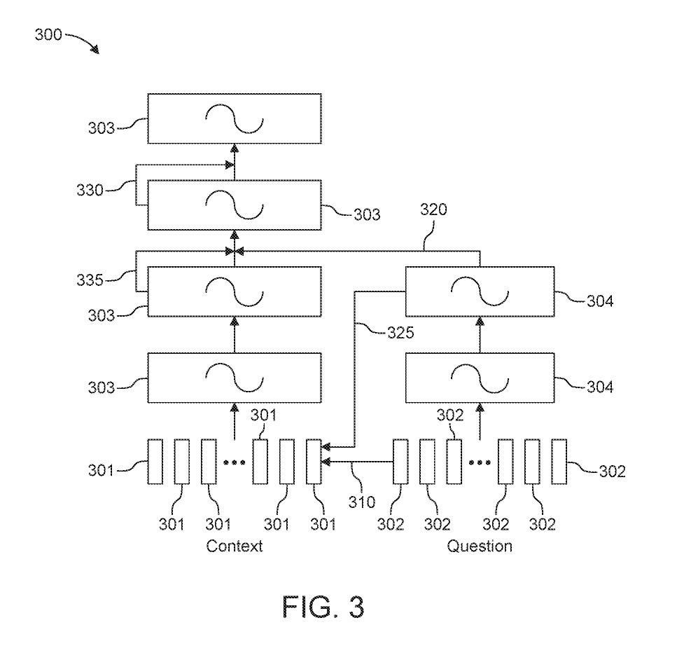

in some aspects of the technology disclosed herein, models for machine reading comprehension use some form of fusion in their architectural design. The success of a model may depend on how to fuse the information between the context C and the question [symbol] . A general architecture illustrating the fusion processes in state-of-the-art architectures is shown in FIG. 3. FIG. 3 is an example conceptual architecture 300 illustrating fusion processes, in accordance with some embodiments. FIG. 3 illustrates input vectors 301 and 302, integration components 303 and 304, and fusion processes 310, 320, 325, 330, and 335. The input vectors 301 are from the context, and the input vectors 302 are from the question. The input vectors 301 and 302 at the bottom are the feature vectors for words in the context and the question. The feature vectors may include a concatenation of the word embedding, which may include the embedding for the part-of-speech of that word. As used herein, the term vector may include, but is not limited to, a one-dimensional array. The integration components of the context 303 and the question 304 represent processing of parts of the context and question to generate higher levels of meaning (e.g., word meaning to phrase meaning, to sentence meaning, to paragraph meaning). In the fusion processes 310, 320, 325, 330, and 335, the input vector 301/302 or integration component 303/304 from which the arrow points is fused into the input vector 301/302 or integration component 303/304 to which the arrow points.

Three main types of fusion processes (among others, in some embodiments) are disclosed herein. The fusion processes 325 and 335 are alternative implementations of the fusion processes 320 and 330, respectively.

Word-level fusion is illustrated at fusion process 310. After mapping word tokens into input vectors, question word level information can he fused into the context at fusion process 310. There are several ways of performing word-level fusion. In some embodiments, the question is used to filter words in the context. In some embodiments, the word-level fusion appends binary features for every word in the context, indicating whether the current context word appears in the question.

High-level fusion is illustrated at fusion processes 320/325. Rather than fusing question word information into the context, some aspects also fuse the high level representation of [symbol] into the high level representation of context C, as illustrated by fusion process 320. In some embodiments, the model uses standard attention-based fusion to fuse into the high level C. In some embodiments, the integration component is coupled with the attention-based fusion process. Alternatively, some embodiments fuse into the context input vectors, as illustrated by fusion process 325.

Self-boosted fusion is illustrated at fusion processes 330/335. Since the context may be long, and distant texts may rely on each other to fully understand the context, some techniques disclosed herein fuse the context into itself. This is illustrated as the fusion processes 330/335.

One common trait of these fusion processes 310, 320/325, and 330/335 is that none of them employs all levels of representation jointly to perform a comprehensive fusion. However, such a comprehensive fusion may be useful for text understanding. Some aspects of the technology described herein relate to a fusion model to address this problem.

The “history of word” concept characterizes the importance of capturing all levels of information to fully understand the text. A light-weight implementation of this concept for neural architectures is described herein. The light-weight implementation comes as an improved attention, which may be termed “fully-aware attention.” Merging fully-aware attention with history of word, some aspects relate to an end-to-end architecture to fuse the complete information between two text bodies,

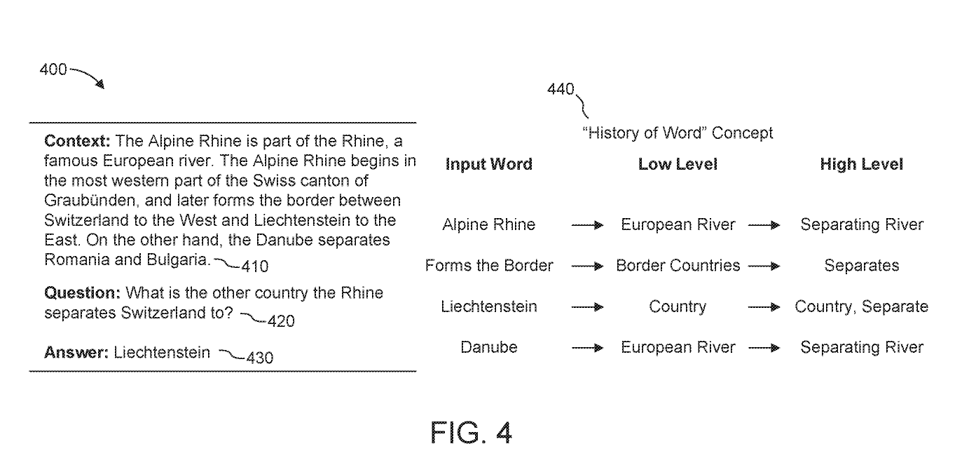

FIG. 4 illustrates example data 400 which may be generated in one implementation, in accordance with some embodiments. As shown, the example data 400 includes a context 410, a question 420, an answer 430 to the question 420, and a “history of word” 440. As shown, the “history of word” 440 includes low level and high level representations for the words of the context 410. The low level and high level representations for “Alpine Rhine,” “forms the border,” “Leichtenstein,” and “Danube” are illustrated.

When a machine reads through the context 410, each input word is gradually transformed into a more abstract representation, for example, becoming low-level and high-level concepts. Together, these low-level and high-level concepts form the history of each word. Human readers may also utilize the history of word when doing reading comprehension exercises. For example, to answer the question 410 correctly, a human may focus on the high-level concept of “forms the border” and on the word information of “Alpine Rhine.” By focusing both on the high-level concepts, a human or a machine may get confused between “Alpine Rhine” and “Danube.” Thus, some machine learning algorithms may incorrectly state that the answer 430 to the question 420 is “Romania” or “Bulgaria,” rather than “Leichtenstein.” Thus, in some cases, the entire history-of-word may be important to fully understand the text.

Some aspects formalize the concept of history-of-word (HoW) in neural architectures. Given a text T (e.g., the context 410 or the question 420), define the history of the i-th word (HoWᵢ) may include the concatenation of all the representations currently generated for this word.

Although it is comprehensive to process all the representations, history-of-word comes at a cost: the resulting concatenation HoW₁ is long and noisy, containing large unrefined components. Using history-of-word throughout the architecture directly makes the model too complex and prone to fail during training. To better incorporate history of word, some aspects present a light-weight implementation, “Fully-aware Attention,” based on attention between two text bodies A and B (e.g., the context 410 and the question 420). The notation may be formally presented as shown in Equations 1 and 2.

{h₁^{x}, . . . , hₘ^{x}}, {h₁^{y}, . . . , hₙ^{y}}⊂R^{d}^{ₕ} Equation 1

Sᵢⱼ=S(hᵢ^{x}, hⱼ^{y}) Equation 2

Define A and B as the sets of hidden vectors for words in two text bodies A and B: A=B={x₁, . . . , xₘ}, B={y₁, . . . , yₘ}⊂R^{d}. Consider the associated history-of-word as shown in Equation 1, where dₕ>>d. Attention between text A and B is controlled by the attention score Sᵢⱼ between i-th vector in A and j-th vector in B. Commonly, Sᵢⱼ=S(xᵢ, yⱼ), as shown in Equation 2. In fully-aware attention, some aspects use the history of word in attention score computation.

This allows the machine to be fully aware of the complete understanding of every word, when some aspects focus their attention on the relevant parts in the text. As some aspects only use history-of-word vector for attention score generation, the architecture will not be directly impacted by the noisy and crude information in the long history vector.

To fully utilize history-of-word in attention, a suitable attention scoring function S(hᵢ^{x}, hⱼ^{y}) may be used. One example of such a function is multiplicative attention: x^{T}U^{T}Vy; leading to Sᵢⱼ=(hᵢ^{x})^{T}U^{T}Vhⱼ^{y}, where U,V ∈R^{k×d}^{ₕ}. To avoid two large matrices interacting directly, some aspects may constrain the matrix U^{T}V to be symmetric, which is equivalent to Sᵢⱼ=(hᵢ^{x})^{T}U^{T}Vhⱼ^{y}, where U ∈R^{k×d}^{ₕ}, D ∈R^{k×k} and D is a diagonal matrix. Additionally, some aspects introduce nonlinearity to the symmetric form to provide richer interaction among different parts of the history-of-word. The final formulation for attention score is Sᵢⱼ=f(Uhᵢ^{x})^{T}Df(Uhⱼ^{y}), where f(x) is an activation function applied to each element. According to sonic aspects, f(x)=max(0, x).

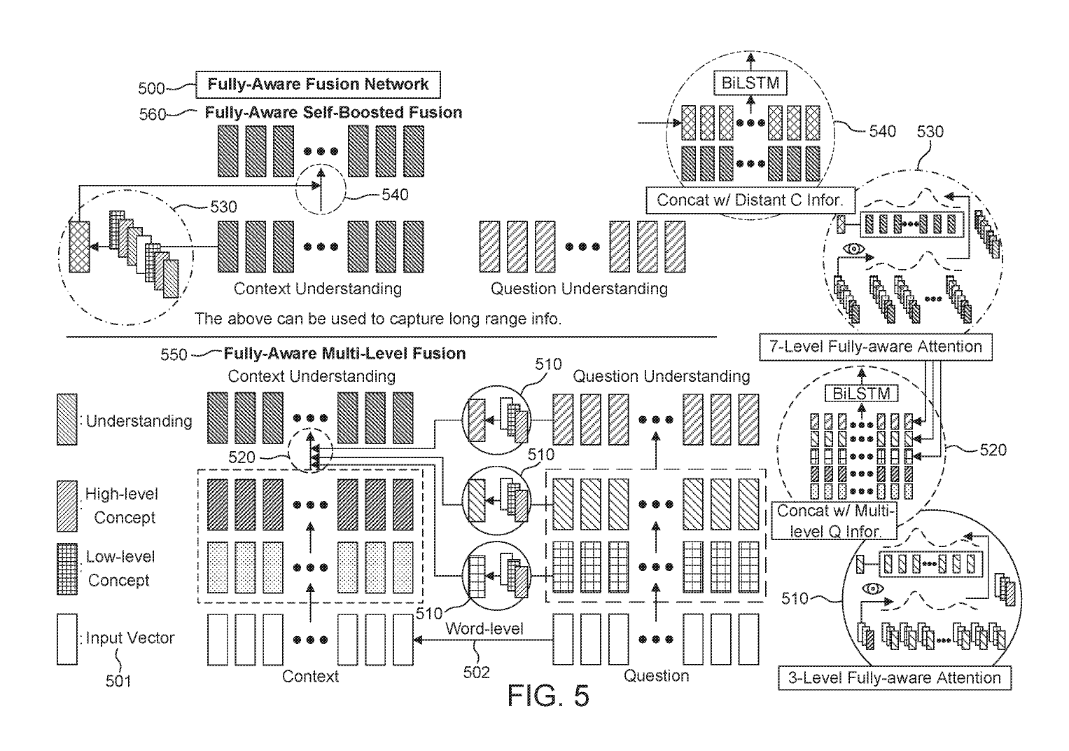

FIG. 5 is an example architecture 500 of a fully aware fusion network, in accordance with some embodiments. The architecture 500 may be used to fuse the information from text B to text A. As discussed herein, text A is the context C (e.g., context 410) and text B is the question [symbol] (e.g., question 420).

As shown, the architecture 500 includes input vector S01, Each word in C and [symbol] corresponds to an input vector w 501. In the fully-aware multi-level fusion module 550, the context and the question are converted to a context understanding and question understanding, respectively, by using three-level fully aware attention 510 and concatenation with multiple level question information 520. At block 520, sonic aspects use two layers of bidirectional long short-term memory (BiLSTM) or other recurrent neural network (RNN) architecture(s). After the two-layer BiLSTM, some aspects obtain a low-level hidden vector h^{l} and a high-level hidden vector h^{h} for each word. Now the history-of-word for C, and [symbol] are both represented as HoW=[w; h^{l}; h^{h}].

As shown in the fully-aware multi-level fusion 540, instead just using the high level concept, h^{h}, some aspects pass all levels of concepts into a BiLSTM to create u, the understanding vector. This is directly applied to the question [symbol] to create the understanding of [symbol] , [symbol] = [symbol] , . . . , [symbol] }. As the understanding part is only for question [symbol] , the common history-of-word for C, [symbol] is still HoW=[w; h¹, h^{h}].

In some aspects, fully-aware multi-level fusion module 550 is used to fuse the complete information in question [symbol] to context C. In fully-aware multi-level fusion module 550, some aspects fuse all levels of information in text [symbol] independently to C. Specifically, some aspects distinguish between fusing the input vectors of [symbol] (word-level) and the hidden vectors of [symbol] (concept-level). For word-level [symbol] , some aspects fuse directly into word-level C before h^{Cl}, h^{Ch} are created. This is illustrated as “word-level” 502 in FIG. 5. This can be achieved using any word-level fusion technique. For concept-level [symbol] , the fusion is completed into high-level C via three-level fully aware attention 510. In the three-level fully-aware attention 510, some aspects use three levels of history-of-words: word-level, low-level and high-level to compute attention weights. Then some aspects use the weights to linearly combine low-level meaning vectors. Some aspects do this two more times and combine high-level and understanding-level vectors. At block 520, the low-level and high-level meanings, plus the three layers of output from 510, are fed into the bidirectional LSTM go get context understanding vectors. At block 530, some aspects use all seven layers of meaning vectors for context words: word-level 501, low-level, high-level, the three output layers from block 510, and the understanding vectors from block 520. Then some aspects do self-attention to generate a meaning vector for each context word. At block 540, some aspects concatenate the output of 530 and the three output layers from block 510 to feed into a bidirectional LSTM to get the final meaning vectors for the context words. Each fusion is done independently and is fully-aware of all level of representation. Focusing on a particular level of concept in [symbol] , the hidden vectors in that level may be denoted as [symbol] , ∀j=1 . . . n, where j is the word index in the question. First, some aspects utilize fully-aware attention 510 with the history-of-word vector HoW=[w, h¹, h^{h}] to compute the attention 60 ᵢⱼ, where i, j are the word index in the context C and the question [symbol] . Even though some aspects are fusing a single level of concept, in some aspects, the machine is fully aware of the entire history-of-word across all levels including word-level information. Thus, some aspects summarize [symbol] , ∀j in the question [symbol] for the i-th word in the context C using ĥᵢ^{C}=Σⱼαᵢⱼ [symbol] . After applying this process independently for each level of concepts in [symbol] , some aspects may obtain the following vectors for the i-th word in the context, ĥᵢ^{Cl}, ĥᵢ^{Ch}, ûᵢ^{C}, corresponding to the attended low-level, high-level and understanding vectors from the question [symbol] . Finally, some aspects combine with all the concept level representations in context C and pass └hᵢ^{Cl}; hᵢ^{Ch}; ĥᵢ^{Cl}; ûᵢ^{C}┘ into a BiLSTM, using concatenation with multi-level question information 520, to get the understanding vectors: U_{C}={uᵢ^{C}, . . . , uₘ^{C}}. Some aspects generate the understanding vectors for both C and [symbol] . Note that the history-of-word for C, [symbol] are now a set forth in Equation 3.

HoW_{C}=[w^{C};h^{Cl};h^{Ch};ĥ^{Cl};û^{C};u^{C}], Ho [symbol] =[ [symbol] ; [symbol] ; [symbol] ; [symbol] ] Equation 3

Fully-aware self-boosted fusion 560 may occur after the information from the question [symbol] is fused into the context C. Two sequences of understanding vectors—Uc and [symbol] —are obtained. However, when the context C is long, a technique to fuse the information from distant parts in the context may be used.

As shown, fully-aware self-boosted fusion 560 includes seven-level fully-aware attention 530. The seven layers of meaning vectors are: word-level 501, low-level, high-level, and the three output layers from block 510, and the understanding vectors from block 520. Some aspects first compute fully-aware attention weights, utilizing the current history-of-word for the context C, HoW_{C}. Then, some aspects concatenate each understanding vector uᵢ^{C} with the attended understanding vector to form: [uᵢ^{C}; Σⱼαᵢⱼuⱼ^{C}]. Finally, at block 540, the understanding vectors are passed them into a BiLSTM to obtain a self-boosted understanding of the context C that is fully-fused with the question [symbol] .

After blocks 530 and 540 are performed, some aspects have created the understanding vectors, U_{C}, for the context C fully fused with the question [symbol] and the understanding vectors, [symbol] , for the question [symbol] . More generally, given two pieces of text A, B, some aspects create embeddings for each word in the text, where the embeddings for A are fully fused with B. These embeddings may be used to perform further natural language processing tasks that require a full understanding between the two pieces of text.

In some implementations, the answer to the question is a span of text in the context. Understanding vectors are generated for the question and the context, as shown in Equation 4.

U_{C}={u₁^{C}, . . . , uₘ^{C}}, [symbol] ={ [symbol] , . . . , [symbol] } Equation 4

Some aspects then utilize U_{C}, [symbol] to find the answer span in the context. Firstly, a single summarized question understanding vector is obtained through [symbol] = [symbol] , where β, ∝ exp (w^{T} [symbol] ) and w is a trainable vector. Then, some aspects predict a position of the span's start using the summarized question understanding vector [symbol] , Pᵢ^{S}∝ exp(( [symbol] )^{T}W_{S}uᵢ^{C}), where W_{S}∈R^{d×d} is a trainable matrix. To use the information of the span start when the span end is being predicted, some aspects combine the context understanding vector for the span start with [symbol] using through a gated recurrent unit (GRU): [symbol] =GRU( [symbol] , ΣᵢPᵢ^{S}uᵢ^{C}, where [symbol] is taken as the memory and ΣᵢPᵢ^{S}uᵢ^{C} as the input in the GRU. Finally some aspects attend for the end of the span using [symbol] , Pᵢ^{E} ∝ exp(( [symbol] )^{T}W_{E}uᵢ^{C}, where W_{E}∈R^{d×d} is another trainable matrix.

During training, some aspects maximize the log probabilities of the ground truth span start and end, Σₖ(log(Pᵢ_{ₖ}_{^{s}}^{S})+log (Pᵢ_{ₖ}_{^{e}}^{E})), where iₖ^{s}, and iₖ^{e} are the answer span for the k^{th} instance. Some aspects predict the answer span to be i^{s}; s^{e} with the maximum Pᵢ_{^{s}}^{S}Pᵢ_{^{e}}^{E} under the constraint 0≤i^{e}−i^{s}≤15. In other words, some aspects include finding the span with length not exceeding 15 (or any other positive integer in place of 15) words that has the highest probability: probability of start at i^{S} multiplied by the probability of end at i^{e}.

Some aspects of the technology described herein relate to a deep learning model for machine reading comprehension (MRC) called FusionNet. One contribution of this model is the attention mechanism, which lies in the center of MRC neural architectures. Some components in FusionNet's attention model include: (1) the concept of “history of words” to incorporate information from lowest word-level embedding up to the highest level representation; (2) a scoring function which is effective in fusing information from context and from the question; and (3) using fully-aware multi-level fusion to capture information from various levels of representation with different attention weights. The new attention model described here may also be used in other NLP tasks beyond MRC.

### NUMBERED EXAMPLES

Certain embodiments are described herein as numbered examples 1, 2, 3, etc. These numbered examples are provided as examples only and do not limit the subject technology.

Example 1 is a system comprising: processing circuitry; and a memory storing instructions which, when executed by the processing circuitry, cause the processing circuitry to perform operations comprising: accessing a context of text and a question related to the context, the context of text comprising a listing of words, each word having a position; determining a low-level meaning of the question and a low-level meaning of the context, the low-level meaning corresponding to words or phrases; determining a high-level meaning of the question and a high-level meaning of the context, the high-level meaning corresponding to sentences or paragraphs; computing, for each position i in the context, a first probability that an answer to the question starts at the position i, the first probability being based on the low-level meaning of the question, the low-level meaning of the context, the high-level meaning of the question, and the high-level meaning of the context; computing, for each position j in the context, a second probability that the answer to the question ends at the position j, the second probability being based on the low-level meaning of the question, the low-level meaning of the context, the high-level meaning of the question, and the high-level meaning of the context; determining the answer to the question based on the computed first probabilities and the computed second probabilities, the answer to the question comprising a contiguous sub-listing of the words in the context; and providing an output representing the answer to the question.

in Example 2, the subject matter of Example 1 includes, wherein the low-level meaning corresponds to a classification of one or more words or phrases.

In Example 3, the subject matter of Examples 1-2 includes, wherein the high-level meaning corresponds to a classification of one or more sentences or a paragraph.

In Example 4, the subject matter of Examples 1-3 includes, the operations further comprising: storing, for each position in the context, a history, the history representing one or more low-level meanings associated with a word at the position and one or more high-level meanings associated with the word, wherein the first probability and the second probability are computed based on the history.

In Example 5, the subject matter of Example 4 includes, the operations further comprising: determining an additional-level meaning of the question and an additional-level meaning of the context, wherein the history represents one or more additional-level meanings associated with the word at the position.

In Example 6, the subject matter of Examples 1-5 includes, the operations further comprising: determining an additional-level meaning of the question and an additional-level meaning of the context, wherein the first probability and the second probability are computed based on the additional-level meaning.

In Example 7, the subject matter of Examples 1-6 includes, wherein determining the answer to the question comprises: determining a first position where the first probability is maximized; determining a second position where the second probability is maximized; determining that the answer to the question comprises the contiguous sub-listing of the words in the context between the first position and the second position.

Example 8 is a machine-readable medium storing instructions which, when executed by processing circuitry of one or more machines, cause the processing circuitry to perform operations comprising: accessing a context of text and a question related to the context, the context of text comprising a listing of words, each word having a position; determining a low-level meaning of the question and a low-level meaning of the context, the low-level meaning corresponding to words or phrases; determining a high-level meaning of the question and a high-level meaning of the context, the high-level meaning corresponding to sentences or paragraphs; computing, for each position i in the context, a first probability that an answer to the question starts at the position i, the first probability being based on the low-level meaning of the question, the low-level meaning of the context, the high-level meaning of the question, and the high-level meaning of the context; computing, for each position j in the context, a second probability that the answer to the question ends at the position j, the second probability being based on the low-level meaning of the question, the low-level meaning of the context, the high-level meaning of the question, and the high-level meaning of the context; determining the answer to the question based on the computed first probabilities and the computed second probabilities, the answer to the question comprising a contiguous sub-listing of the words in the context; and providing an output representing the answer to the question.

In Example 9, the subject matter of Example 8 includes, wherein the low-level meaning corresponds to a classification of one or more words or phrases.

In Example 10, the subject matter of Examples 8-9 includes, wherein the high-level meaning corresponds to a classification of one or more sentences or a paragraph.

In Example 11, the subject matter of Examples 8-10 includes, the operations further comprising: storing, for each position in the context, a history, the history representing one or more low-level meanings associated with a word at the position and one or more high-level meanings associated with the word, wherein the first probability and the second probability are computed based on the history.

In Example 12, the subject matter of Example 11 includes, the operations further comprising: determining an additional-level meaning of the question and an additional-level meaning of the context, wherein the history represents one or more additional-level meanings associated with the word at the position.

In Example 13, the subject matter of Examples 8-12 includes, the operations further comprising: determining an additional-level meaning of the question and an additional-level meaning of the context, wherein the first probability and the second probability are computed based on the additional-level meaning.

In Example 14, the subject matter of Examples 8-13 includes, wherein determining the answer to the question comprises: determining a first position where the first probability is maximized; determining a second position where the second probability is maximized; determining that the answer to the question comprises the contiguous sub-listing of the words in the context between the first position and the second position.

Example 15 is a method comprising: accessing a context of text and a question related to the context, the context of text comprising a listing of words, each word having a position; determining a low-level meaning of the question and a low-level meaning of the context, the low-level meaning corresponding to words or phrases; determining a high-level meaning of the question and a high-level meaning of the context, the high-level meaning corresponding to sentences or paragraphs; computing, for each position i in the context, a first probability that an answer to the question starts at the position the first probability being based on the low-level meaning of the question, the low-level meaning of the context, the high-level meaning of the question, and the high-level meaning of the context; computing, for each position j in the context, a second probability that the answer to the question ends at the position j, the second probability being based on the low-level meaning of the question, the low-level meaning of the context, the high-level meaning of the question, and the high-level meaning of the context; determining the answer to the question based on the computed first probabilities and the computed second probabilities, the answer to the question comprising a contiguous sub-listing of the words in the context; and providing an output representing the answer to the question.

In Example 16, the subject matter of Example 15 includes, wherein the low-level meaning corresponds to a classification of one or more words or phrases.

In Example 17, the subject matter of Examples 15-16 includes, wherein the high-level meaning corresponds to a classification of one or more sentences or a paragraph.

In Example 18, the subject matter of Examples 15-17 includes, storing, for each position in the context, a history, the history representing one or more low-level meanings associated with a word at the position and one or more high-level meanings associated with the word, wherein the first probability and the second probability are computed based on the history.

In Example 19, the subject matter of Example 18 includes, determining an additional-level meaning of the question and an additional-level meaning of the context, wherein the history represents one or more additional-level meanings associated with the word at the position.

In Example 20, the subject matter of Examples 15-19 includes, determining an additional-level meaning of the question and an additional-level meaning of the context, wherein the first probability and the second probability are computed based on the additional-level meaning.

In Example 21, the subject matter of Examples 15-20 includes, wherein determining the answer to the question comprises: determining a first position where the first probability is maximized; determining a second position where the second probability is maximized; determining that the answer to the question comprises the contiguous sub-listing of the words in the context between the first position and the second position.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

### Components and Logic

Certain embodiments are described herein as including logic or a number of components or mechanisms. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

Accordingly, the phrase “hardware component” should be understood to encompass a tangible record, be that an record that is physically constructed, permanently configured (e.g., hardwired), or temporarily configured (e.g., programmed) to operate in a certain manner or to perform certain operations described herein. As used herein, “hardware-implemented component” refers to a hardware component. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e,g., an API),

The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

Some aspects of the subject technology involve collecting personal information about users. It should be noted that the personal information about a user is collected after receiving affirmative consent from the users for the collection and storage of such information. Persistent reminders (e.g., email messages or information displays within an application) are provided to the user to notify the user that his/her information is being collected and stored. The persistent reminders may be provided whenever the user accesses an application or once every threshold time period (e.g., an email message every week). For instance, an arrow symbol may be displayed to the user on his/her mobile device to notify the user that his/her global positioning system (GPS) location is being tracked. Personal information is stored in a secure manner to ensure that no unauthorized access to the information takes place. For example, medical and health related information may be stored in a Health Insurance Portability and Accountability Act (HIPAA) compliant manner.

### Example Machine and Software Architecture

The components, methods, applications, and so forth described in conjunction with FIGS. 1-5 are implemented in some embodiments in the context of a machine and an associated software architecture. The sections below describe representative software architecture(s) and machine (e.g., hardware) architecture(s) that are suitable for use with the disclosed embodiments,

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the disclosed subject matter in different contexts from the disclosure contained herein.

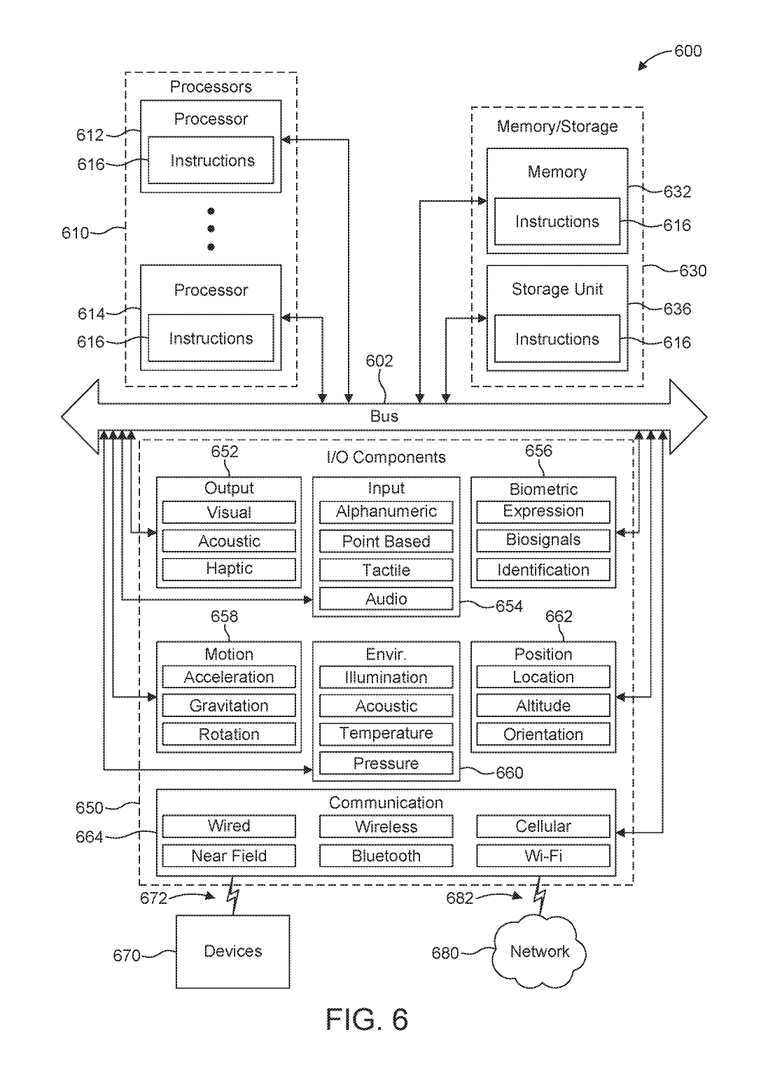

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. The instructions 616 transform the general, non-programmed machine into a particular machine programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, PC, a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory/storage 630, and I/O components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions contemporaneously. Although FIG. 6 shows multiple processors 610, the machine 600 may include a single processor with a single core, a single processor with multiple cores (e.g., a multi-core processor), multiple processors with a single core, multiple processors with multiples cores, or any combination thereof.

The memory/storage 630 may include a memory 632, such as a main memory, or other memory storage, and a storage unit 636, both accessible to the processors 610 such as via the bus 602. The storage unit 636 and memory 632 store the instructions 616 embodying any one or more of the methodologies or functions described herein. The instructions 616 may also reside, completely or partially, within the memory 632, within the storage unit 636, within at least one of the processors 610 (e.g., within the processor's cache memory), or any suitable combination thereof, during execution thereof by the machine 600. Accordingly, the memory 632, the storage unit 636, and the memory of the processors 610 are examples of machine-readable media.

As used herein, “machine-readable medium” means a device able to store instructions (e.g., instructions 616) and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 616. The term “machine-readable medium” shall also be taken to include any medium, or combination of multiple media, that is capable of storing instructions (e.g., instructions 616) for execution by a machine (e.g., machine 600), such that the instructions, when executed by one or more processors of the machine (e.g., processors 610), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components speakers), haptic components (e.g., a vibratory motor, resistance mechanisms), other signal generators, and so forth. The input components 654 may include alphanumeric input components e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), measure exercise-related metrics (e.g., distance moved, speed of movement, or time spent exercising) identify a person (e.g., voice identification, retinal identification, facial identification, fingerprint identification, or electroencephalogram based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672, respectively. For example, the communication components 664 may include a network interface component or other suitable device to interface with the network 680. In further examples, the communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a USB).

Moreover, the communication components 664 may detect identifiers or include components operable to detect identifiers. For example, the communication components 664 may include Radio Frequency Identification (RFD) tag reader components, NEC smart tag detection components, optical reader components, or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

In various example embodiments, one or more portions of the network 680 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network and the coupling 682 may he a Code Division Multiple Access (CDMA) connection, a Global System for Mobile communications (GSM) connection, or another type of cellular or wireless coupling. In this example, the coupling 682. may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 6G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 670. The term “transmission medium” shall be taken to include any intangible medium that is capable of storing, encoding, or carrying the instructions 616 for execution by the machine 600, and includes digital or analog communications signals or other intangible media to facilitate communication of such software.

What is claimed is:

1. A system comprising:
processing circuitry; and
a memory storing instructions which, when executed by the processing circuitry, cause the processing circuitry to perform operations comprising:
accessing a context of text and a question related to the context, the context of text comprising a listing of words, each word having a position;
determining a low-level meaning of the question and a low-level meaning of the context, the low-level meaning corresponding to words or phrases;
determining a high-level meaning of the question and a high-level meaning of the context, the high-level meaning corresponding to sentences or paragraphs;
computing, for each position i in the context, a first probability that an answer to the question starts at the position i, the first probability being based on the low-level meaning of the question, the low-level meaning of the context, the high-level meaning of the question, and the high-level meaning of the context;
computing, for each position j in the context, a second probability that the answer to the question ends at the position j, the second probability being based on the low-level meaning of the question, the low-level meaning of the context, the high-level meaning of the question, and the high-level meaning of the context;
determining the answer to the question based on the computed first probabilities and the computed second probabilities, the answer to the question comprising a contiguous sub-listing of the words in the context; and
providing an output representing the answer to the question.

2. The system of claim I, wherein the low-level meaning corresponds to a classification of one or more words or phrases.

3. The system of claim 1, wherein the high-level meaning corresponds to a classification of one or more sentences or a paragraph.

4. The system of claim 1, the operations further comprising:
storing, for each position in the context, a history, the history representing one or more low-level meanings associated with a word at the position and one or more high-level meanings associated with the word, wherein the first probability and the second probability are computed based on the history.

5. The system of claim 4, the operations further comprising:
determining an additional-level meaning of the question and an additional-level meaning of the context, wherein the history represents one or more additional-level meanings associated with the word at the position.

6. The system of claim 1, the operations further comprising:
determining an additional-level meaning of the question and an additional-level meaning of the context, wherein the first probability and the second probability are computed based on the additional-level meaning.

7. The system of claim 1, wherein determining the answer to the question comprises:
determining a first position where the first probability is maximized;
determining a second position where the second probability is maximized;
determining that the answer to the question comprises the contiguous sub-listing of the words in the context between the first position and the second position.

8. A non-transitory machine-readable medium storing instructions which, when executed by processing circuitry of one or more machines, cause the processing circuitry to perform operations comprising:
accessing a context of text and a question related to the context, the context of text comprising a listing of words, each word having a position;
determining a low-level meaning of the question and a low-level meaning of the context, the low-level meaning corresponding to words or phrases;
determining a high-level meaning of the question and a high-level meaning of the context, the high-level meaning corresponding to sentences or paragraphs;
computing, for each position i in the context, a first probability that an answer to the question starts at the position i, the first probability being based on the low-level meaning of the question, the low-level meaning of the context, the high-level meaning of the question, and the high-level meaning of the context;
computing, for each position j in the context, a second probability that the answer to the question ends at the position j, the second probability being based on the low-level meaning of the question, the low-level meaning of the context, the high-level meaning of the question, and the high-level meaning of the context;
determining the answer to the question based on the computed first probabilities and the computed second probabilities, the answer to the question comprising a contiguous sub-listing of the words in the context; and
providing an output representing the answer to the question.

9. The machine-readable medium of claim 8, wherein the low-level meaning corresponds to a classification of one or more words or phrases.

10. The machine-readable medium of claim 8, wherein the high-level meaning corresponds to a classification of one or more sentences or a paragraph.

11. The machine-readable medium of claim 8, the operations further comprising:
storing, for each position in the context, a history, the history representing one or more low-level meanings associated with a word at the position and one or more high-level meanings associated with the word, wherein the first probability and the second probability are computed based on the history.

12. The machine-readable medium of claim 11, the operations further comprising:
determining an additional-level meaning of the question and an additional-level meaning of the context, wherein the history represents one or more additional-level meanings associated with the word at the position.

13. The machine-readable medium of claim 8, the operations further comprising:
determining an additional-level meaning of the question and an additional-level meaning of the context, wherein the first probability and the second probability are computed based on the additional-level meaning.

14. The machine-readable medium of claim 8, wherein determining the answer to the question comprises:
determining a first position where the first probability is maximized;
determining a second position where the second probability is maximized;
determining that the answer to the question comprises the contiguous sub-listing of the words in the context between the first position and the second position.

15. A method comprising:
accessing a context of text and a question related to the context, the context of text comprising a listing of words, each word having a position;
determining a low-level meaning of the question and a low-level meaning of the context, the low-level meaning corresponding to words or phrases;
determining a high-level meaning of the question and a high-level meaning of the context, the high-level meaning corresponding to sentences or paragraphs;
computing, for each position i in the context, a first probability that an answer to the question starts at the position i, the first probability being based on the low-level meaning of the question, the low-level meaning of the context, the high-level meaning of the question, and the high-level meaning of the context;
computing, for each position j in the context, a second probability that the answer to the question ends at the position j the second probability being based on the low-level meaning of the question, the low-level meaning of the context, the high-level meaning of the question, and the high-level meaning of the context;
determining the answer to the question based on the computed first probabilities and the computed second probabilities, the answer to the question comprising a contiguous sub-listing of the words in the context; and
providing an output representing the answer to the question.

16. The method of claim 15, wherein the low-level meaning corresponds to a classification of one or more words or phrases.

17. The method of claim 15, wherein the high-level meaning corresponds to a classification of one or more sentences or a paragraph.

18. The method of claim 15, further comprising:
storing, for each position in the context, a history, the history representing one or more low-level meanings associated with a word at the position and one or more high-level meanings associated with the word, wherein the first probability and the second probability are computed based on the history.

19. The method of claim 18, further comprising:
determining an additional-level meaning of the question and an additional-level meaning of the context, wherein the history represents one or more additional-level meanings associated with the word at the position.

20. The method of claim 15, further comprising:
determining an additional-level meaning of the question and an additional-level meaning of the context, wherein the first probability and the second probability are computed based on the additional-level meaning.
